(19) United States
(12) Patent Application Publication
(10) Pub. No.: US 2026/0112603 A1
(43) Pub. Date: Apr. 23, 2026

(54) Carbon-Nanotube Carpet with Polymer Adhesive

(71) Applicant: Zeta Energy LLC, Houston, TX (US)

(72) Inventors: Abdul-Rahman Olabode Raji, Houston, TX (US); Tuo Wang, Houston, TX (US); Rodrigo Villegas Salvatierra, Houston, TX (US); Li He, Pearland, TX (US); Akshaya Bhashyam, Katy, TX (US)

(21) Appl. No.: 18/835,671

(22) PCT Filed: Feb. 14, 2024
(86) PCT No.: PCT/US2024/015791

§ 371 Date: Aug. 2, 2024

Related U.S. Application Data
(60) Provisional application No. 63/502,821, filed on May 17, 2023.

(51) Int. Cl. H01M 4/133; C01B 32/162; H01M 4/1393; H01M 4/62

(52) U.S. Cl. CPC H01M 4/133; C01B 32/162; H01M 4/1393; H01M 4/622; C01B 2202/22

(57) ABSTRACT

A carpet of carbon nanotubes (CNTs) extends from a conductive substrate. The CNTs are bundled, and the bundles are bonded to the substrate to create low-resistance connections. A polymeric adhesive around the bases of the bundles binds the CNTs to the substrate without interfering with the low-resistance connection. The bundles can be organized into interconnected walls defining an irregular mosaic of valleys.

### FIELD OF THE INVENTION

The subject matter presented herein relates generally to electrodes for energy-storage devices.

### BACKGROUND

Carbon nanotubes (CNTs) are cylindrical molecules of carbon arranged in a hexagonal lattice. CNTs can be grown from or applied to substrates to form microscopic carpets with high surface area and electrical conductivity, properties that make such carpets useful as electrodes in electrochemical and electrostatic energy-storage devices. In an anode for an electrochemical cell, for example, a CNT carpet can be grown from an electrically conductive current collector. Unfortunately, CNTs thus grown can detach from the current collector, a problem that complicates cell assembly and can limit reliability during manufacturing and product use.

### SUMMARY

An electrode and methods for its fabrication use carbon nanofilaments such as carbon nanotubes and carbon nanoribbons. The electrode comprises a conductive substrate with bundles of carbon nanofilaments that have specific spacing characteristics: the bases of the bundles are attached to the substrate with an average spacing greater than ten nanometers, while the tops of the bundles have an average inter-filament spacing of less than five nanometers. A solid polymer adhesive, which can include polyacrylonitrile, is integrated between these bundles and in contact with the bases and the conductive substrate. The polymer may be ionically permeable, porous, and electrically insulating, with molecular weights of less than 5 MDa or cluster sizes of more than 1 μm.

A metal coating can be applied over the polymer and between the carbon nanofilaments to achieve a current density of at least 1 mA/cm² within a specific voltage range. The conductive substrate may include copper with an interfacial layer that attaches to the bundles, potentially including a catalyst to aid the growth of the bundles.

A method for binding carbon nanofilaments to a substrate wets the substrate with a polymer solution that, when dried, leaves a polymer residue that binds the filaments to the substrate. This electrode design and fabrication method are potentially advantageous for applications requiring high surface area, efficient electrical conduction, and structural integrity, such as in energy storage devices, sensors, and electronic components.

Nanofilament carpets in some embodiments have evenly distributed bundles of carbon nanotubes. In other embodiments, an adhesive-application process reforms the bundles into an irregular mosaic of wall separating microscopic valleys. The valleys occupy a significantly larger volume fraction compared to the intra-wall volume. This carpet structure is bonded to the substrate with a solid polymer, and the walls'thickness tapers off with distance from the substrate, creating a mosaic of valleys when viewed from above.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A depicts an electrode 100 in which a CNT carpet 105 extends from an interfacial layer 110 on a current collector 115.

FIG. 1B depicts a portion 186 of a CNT carpet in accordance with an embodiment that uses a drying process that does not preserve CNT morphology.

FIG. 1C depicts a portion 191 of a CNT carpet in accordance with another embodiment.

FIG. 2 includes top-down views of a CNT carpet 200 prior to the adhesive-application process 170 of FIG. 1A and an irregular mosaic 205 of the same CNT carpet 200 after an adhesive-application process.

FIG. 3 shows top-down views of irregular mosaic 205 of FIG. 2 at higher levels of magnification, 500× and 10,000× respectively for the upper and lower depictions.

FIG. 4 depicts a cross section 400 of a portion of CNT carpet 200 and a cross section 405 of a wall 210 of CNT mosaic 205.

FIG. 5 includes top views 500 and 505 of CNT mosaic 205 at magnification levels of 100× and 500×, respectively.

FIG. 6 shows a graph 600 relating the average hydrodynamic volume or cluster size of a 1.8 wt % polyacrylonitrile polymer solution with the sizes of valleys 215 between walls 210 in patterned CNT carpet 189.

### DETAILED DESCRIPTION

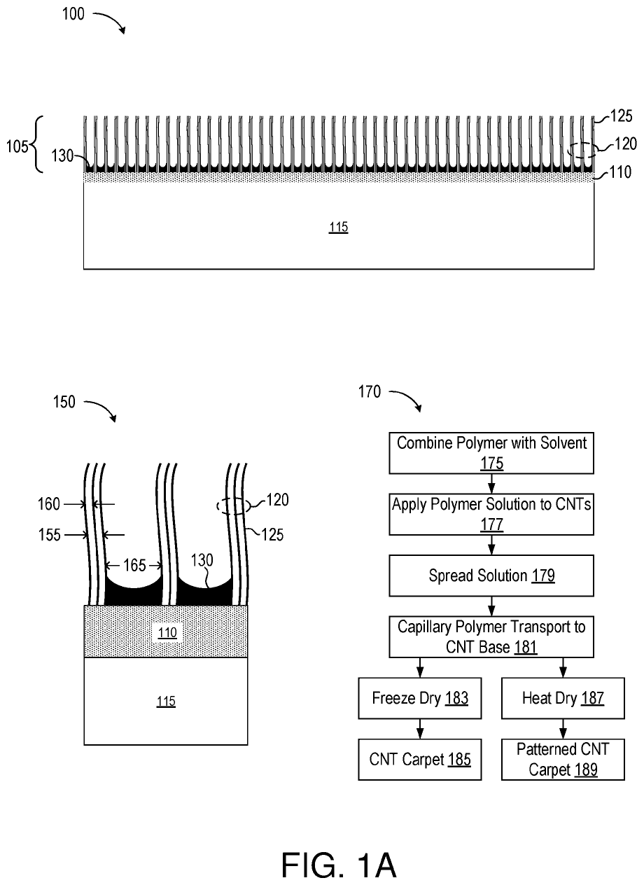

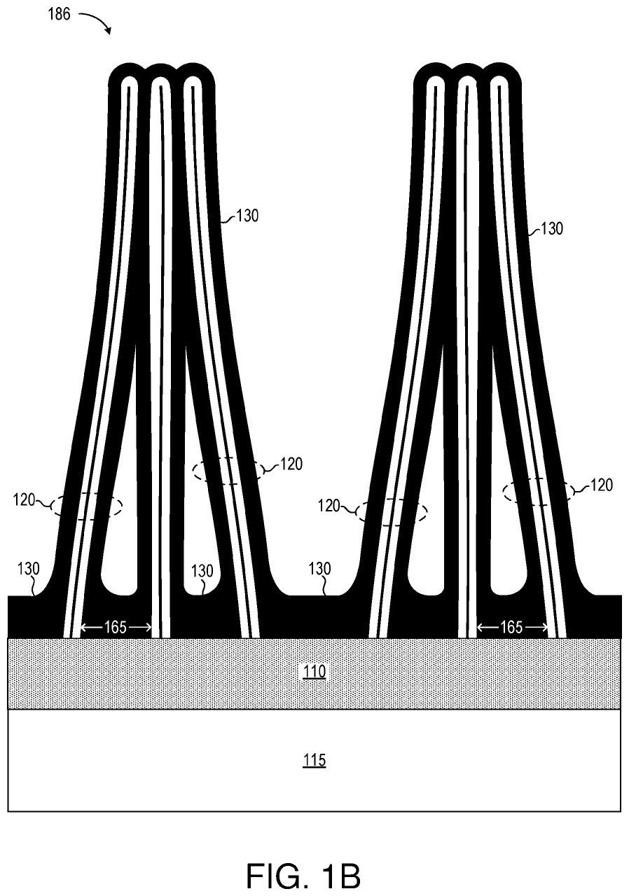

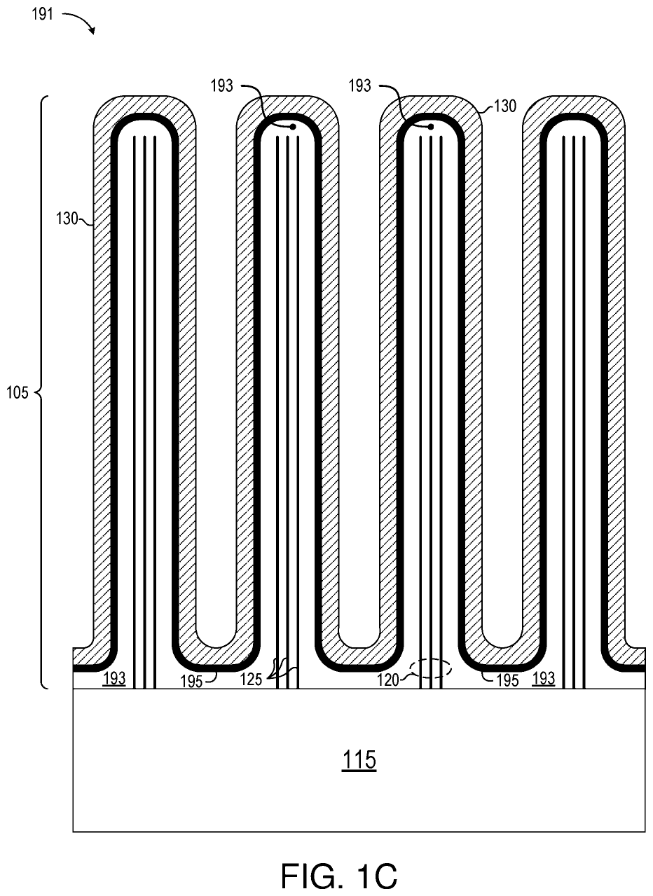

FIG. 1A depicts an electrode 100 in which a carbon-nanotube (CNT) carpet 105 extends from an interfacial layer 110 on a current collector 115. CNT carpet 105 includes bundles 120 of CNTs 125 that are reliably bonded to interfacial layer 110 by a polymeric adhesive 130, a solid polymer that does not interrupt the low-impedance, electrically conductive path from current collector 115 to CNTs 125. Adhesive 130 is ionically permeable and bundles 120 extend generally away from interfacial layer 110 so the paths for ions in and out of carpet 105 are of low ionic impedance. The areal density of CNT carpet 105 is on the order of hundreds or thousands of square meters per gram, providing ample storage for alkali-metal plating or ion intercalation. These properties make electrode 100 an excellent candidate for energy storage, e.g. in electrochemical cells, supercapacitors, or hybrid supercapacitors.

The following discussion assumes electrode 100 is an anode in a lithium-metal cell. The capacity of anode 100 is a function of the quantity of lithium metal that can be stored over and between CNT bundles 120, while the electrical impedance is a function of the ease with which charge carriers—Li cations and electrons—can enter and leave the bundles. Current collector 115 is or includes a base layer predominantly of copper, in one embodiment a 99.9% pure, 8 um copper foil. Interfacial layer 110, formed during the manufacture of electrode 100, can be of a copper alloy with a catalyst, such as iron, to catalyze CNT growth. Interfacial layer 110 can include other elements, such as oxygen, that may or may not catalyze CNT growth, and some of the catalyst used in CNT formation can be incorporated into the CNTs. The oxygen may come from native or grown surface copper oxide. The other elements may include metals, such as Ag, Ni, Cr, Al, Fe, or Zn that are intentionally or unintentionally introduced. Some embodiments lack interfacial layer 110 so that the CNTs are essentially on current collector 115, possibly with trace amounts of e.g. catalyst and disordered carbon. Suitable methods for growing CNT carpet 105 on copper substrates are detailed in U.S. Patent Publication No. 2022/0359859 to Raji et al., which is incorporated herein by reference. Raji et al. also describe and illustrate how an anode incorporating a CNT carpet can be combined with a sulfurized-carbon cathode and other elements to form an electrochemical cell. Nanofilaments grown from a substrate need not be vertical, straight, or aligned. In other embodiments, ordered or disordered nanofilaments can be formed separate from and adhered to a substrate via adhesive 130.

A portion 150 of anode 100 is depicted at the lower left of FIG. 1A to emphasize dimensions and features of the CNT carpet. CNTs 125 can be grouped into bundles 120 of a few or many CNTs 125. The average bundle diameter 155 is about 10 nm in one embodiment. The average inter-CNT spacing 160 is less than 5 nm, less than 2 nm in some examples. The average inter-bundle spacing 165 is considerably more, greater than 10 nm, and likely greater than 100 nm. Spacings 165 can be characterized by measuring the porosity of CNT carpet 105. A sample with a pore volume of 1.61 cubic centimeters per gram had a peak pore width of 3.8 nm over a measured range of about 1.3 nm to 40 nm. Adhesive 130 is e.g. polyimide, polyacrylic acid, polyethylene oxide bonded to the bases of CNT bundles 120 and the upper surface of interfacial layer 110. Adhesive 130 is shown at the bottom of carpet 105 to illustrate the connectivity it provides between bundles 120 and layer 110, but the polymer can extend upward to cover more of bundles 120.

A flowchart 170 in the lower right of FIG. 1A depicts a process of applying adhesive 130 to CNT carpet 105. An aqueous solution of 0.3 wt % polyacrylic acid in water is mixed using a centrifugal planetary mixer at 800 rpm for two minutes (175). Polymers selected for the polyacrylic acid had molecular weights of 0.15 MDa, 0.45 MDa, and 1.25 MDa, all of which improved CNT adhesion relative to electrodes that lacked adhesive 130. In another embodiment, a solution of 0.5 wt % polyvinylidene fluoride (PVDF) with molecular weight of 0.15 MDa was mixed with N-Methylpyrrolidone (NMP).

The polymer solution of 175 is applied to a dry CNT carpet 105 lying flat on a coating machine (177) and the solution is spread using a slot die or doctor blade (179). During spreading, the solution flows to the base of carpet 105 and wets areas between bundles 120. Further polymer transport is accomplished by diffusion during a waiting period of e.g. ten minutes at room temperature (181). Electrode 100 is then freeze dried (183) to evaporate the solvent without dramatically reorienting bundles 120. This process leaves a solid polymer residue of adhesive 130, which forms a CNT carpet 185 in which adhesive 130 provides strong physical bonds joining bundles 120 to layer 110. Critical-point drying can be used in lieu of freeze drying to maintain the morphology of carpet 105 during drying.

FIG. 1B depicts a portion 186 of a CNT carpet in accordance with an embodiment that uses a drying process that does not preserve CNT morphology. For example, step 187 of process 170 (FIG. 1A) dries the polymer solution in the CNT carpet at seventy degrees Celsius for thirty minutes. Capillary action during this drying process pulls the ends of bundles 120 together so that inter-bundle spacing 165 reduces as a function of distance from substrate 115. That is, bundle bases attached to the conductive substrate have an average inter-bundle spacing greater than bundle tops. In one example, the bundle bases have an average inter-bundle spacing greater than ten nanometers and the bundle tops have an average inter-bundle spacing of less than five nanometers. Adhesive 130 tends to fill the inter-bundle spaces, and the volume of adhesive 130 may be higher as a function of distance from the substrate. This effect reorganizes CNT bundles 120 into a patterned CNT carpet with very different morphology and pore distribution than the more regular CNT carpet 185, and concomitantly improved electrochemical properties, e.g. increased electrochemical cycle stability.

The molecules of polymer adhesive 130 can be too large to significantly infiltrate bundles 120, can be porous, and can cover more or fewer bundles 120. Adhesive 130 is an ion permeable material. Adhesive 130 can absorb liquid electrolyte and increase the anode surface area, porosity, or both for improved ion conduction. To these ends, adhesive 130 can be intrinsically porous to facilitate absorption of liquid electrolyte. Adhesive 130 can be an ion conductor, capable of transporting ions with or without a solid or liquid electrolyte.

Adhesive 130 can be e.g. polyacrylic acid, lithium polyacrylic acid, sodium carboxymethylcellulose, cellulose, polyacrylonitrile, acrylonitrile multi-copolymers, polyurethanes, epoxy resins, polyimides, polyetherimides (a flame-retardant polymer), rubbers, polyesters, polyolefins (e.g. polyethylene, polypropylene), polyethylene oxide (polyethylene glycol), polyvinylidene difluoride, and combinations thereof. In addition to the processes of flowchart 170, an adhesive to bind or stabilize CNT carpet 105 with respect to current collector 115 can be applied by e.g. physical vapor deposition, electron beam evaporation, thermal evaporation, sputter deposition, pulsed laser deposition, chemical vapor deposition, spraying, spray coating, sputtering, coating, spin coating, blade coating, rod coating, film coating, printing, painting, brushing, mechanical transfer, annealing, and combinations thereof.

When incorporated into an electrochemical cell, electrode 100 can reversibly store a reductant within and between bundles 120 and CNTs 125 by plating, e.g. with a metal, or intercalation, e.g. with ions. In Raji et al., referenced above, an electrochemical cell is charged by electroplating lithium metal over and between CNTs. Adhesive 130 can be electrically insulating and is ionically permeable, the latter describing a material that absorbs or includes a solid or liquid electrolyte or is an ion conductor. As used herein, a material is permeable to lithium ions if it allows for lithium deposition within a CNT carpet at a current density of at least 1 mA/cm² within a voltage range of +/−0.1 V vs Li⁺/Li. An electrically insulating and ionically permeable adhesive layer can block dendrite formation on CNTs 125 by preventing lithium ions from combining with electrons until they traverse the adhesive layer. Lithium metal can thus form entirely or predominantly between adhesive 130 and CNTs 125 rather than on the side of adhesive 130 opposite the CNTs.

FIG. 1C depicts a portion 191 of a CNT carpet in accordance with another embodiment. The process of flowchart 170 is modified to apply a solution of an electrically conductive polymer to CNT bundles 120, the entire CNT carpet 105, before applying adhesive 130. The coating of electrically conductive polymer is dried, leaving an electrically conductive polymer adhesive 193 over and between bundles 120. The process of flowchart 170 then commences to apply a layer of electrically insulating, ionically permeable adhesive 130. When the electrode is subsequently lithiated, during cell construction or charging, ions traverse layer 130 to combine with electrons at the interface of layer 130 and 193 to form an intermediate metallic layer 195. Preventing metal ions from combining with electrons until they traverse electrically insulating adhesive 130 prevents dendrite formation.

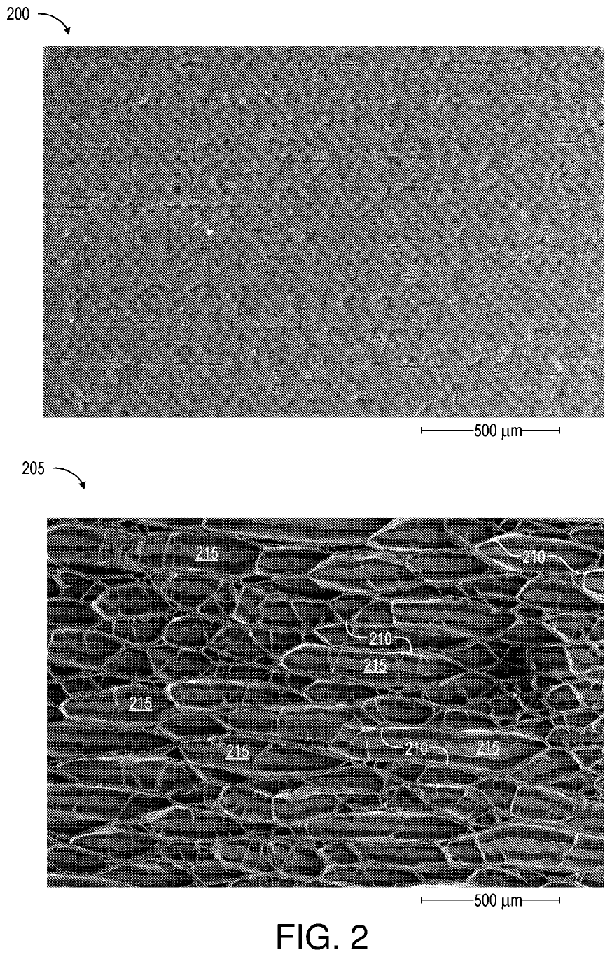

FIG. 2 includes a top-down view of a CNT carpet 200 prior to the adhesive-application process 170 of FIG. 1A. The CNT bundles are relatively evenly distributed. FIG. 2 also includes a top-down view of an irregular mosaic 205, the same CNT carpet 200 after an adhesive-application process 170 of FIG. 1A in which the polymer of step 175 was polyacrylic acid with a molecular weight of 0.45 MDa and the drying was by application of heat. In step 187, the evaporating solvent densified CNT bundles 120 into walls 210 separating microscopic valleys 215. The porosity of the resultant irregular mosaic has a very different pore distribution than carpet 200. The normalized surface volume of a CNT carpet is the collective space unoccupied by CNTs 125 or adhesive 130 in a rectangular prism encompassing the CNT carpet. This space is available for electrolyte in assembled cells. Valleys 215 exhibit a volume fraction of the normalized surface volume that is more than twice the intra-wall volume fraction of walls 210. In some embodiments, the valley volume fraction is up to twenty times the intra-wall volume fraction. CNT densification can also be observed in the cross sections of walls 210; the widths of walls 210 near the tips of CNTs 125—the tops of walls 210—being on average less than half the widths of walls 210 near the bases in this example.

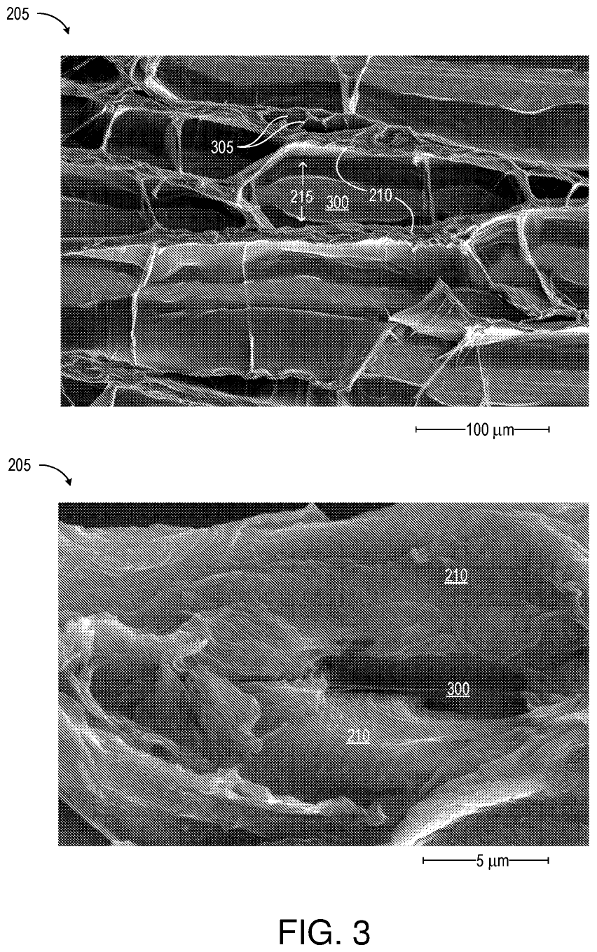

FIG. 3 shows top-down views of irregular mosaic 205 of FIG. 2 at higher levels of magnification, 500× and 10,000× respectively for the upper and lower depictions.

Adhesive 130 binds bundles 120 into vertical walls 210 and coats valleys 215 and valley floors 300. The upper depiction shows walls 210 include lamellas 305, layered groups of CNTs 125 and CNT bundles 120. The higher magnification of the lower depiction shows dense packing of CNTs 125 that form walls 210. The walls are oriented vertically relative to the substrate.

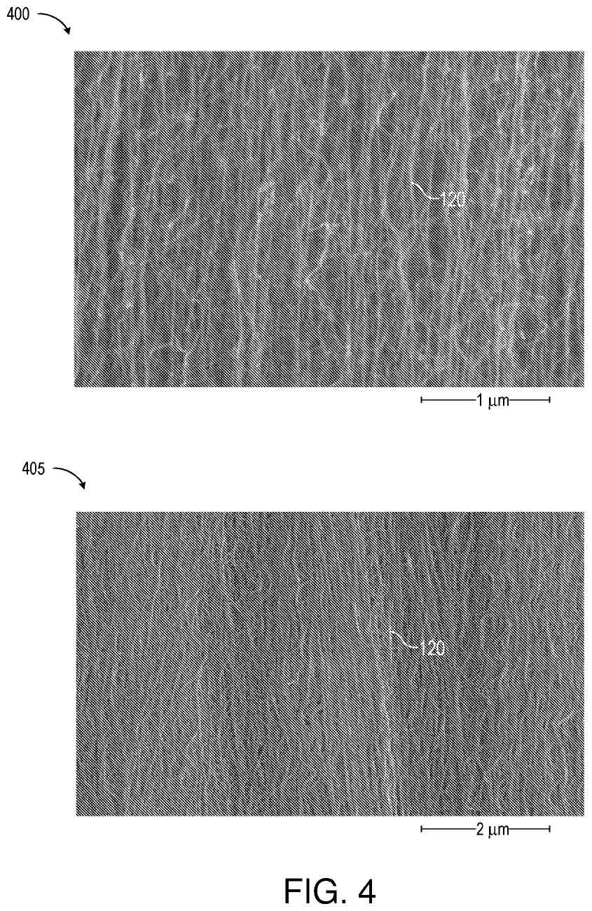

FIG. 4 depicts a cross section 400 of a portion of CNT carpet 200 and a cross section 405 of a wall 210 of CNT mosaic 205. Taken together, cross sections 400 and 405 illustrate the densification of CNT bundles 120 because of process 170 with heat drying 187.

Inter-bundle spacing 165 is dramatically reduced.

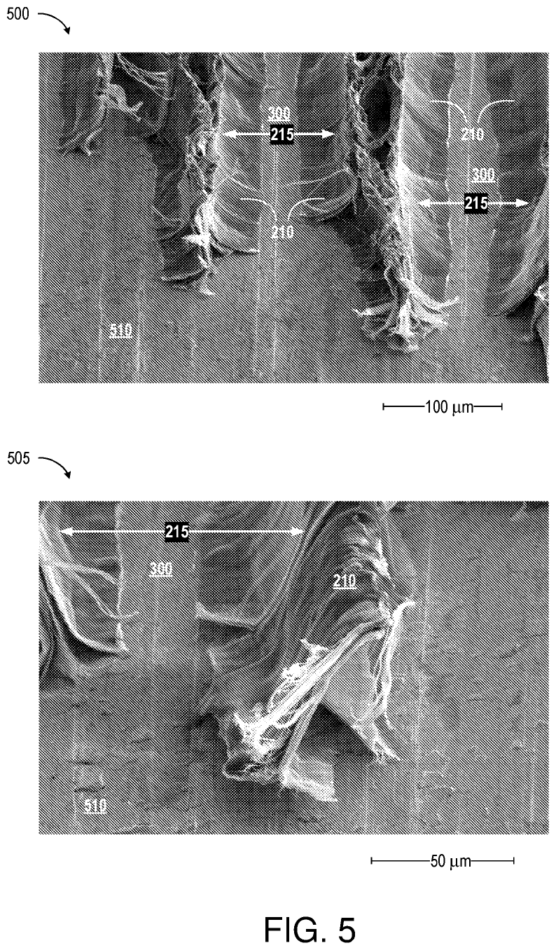

FIG. 5 includes top views 500 and 505 of CNT mosaic 205 at magnification levels of 100× and 500×, respectively. These views show the ends of some walls 210 and surface 510 of the underlying substrate. Adhesive 130 coats CNT bundles 120 within, over, and between walls 210. Some bundles pull away from the substrate, one or both of layers 110 and 115, leaving denuded floors 300 within valleys 215. Bundles 120 tend to come together as they extend from the substrate so that valleys 215 tend to be bowl-shaped in cross section and walls 210 somewhat triangular in cross section. Adhesive 130 coats CNT bundles 120, walls 210, and floors 300. In this example, there tends to be more adhesive 130 near the tops of walls 210 than at the bases, but the entire mosaic tends to be coated and infused with the adhesive.

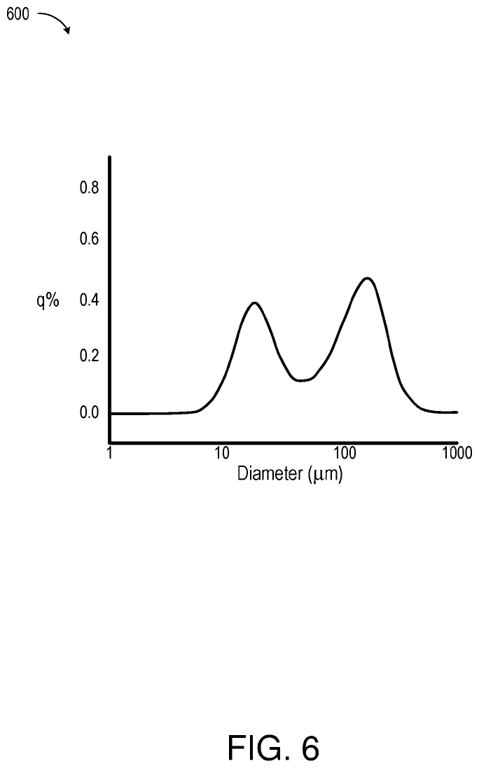

FIG. 6 shows a graph 600 relating the average hydrodynamic volume or cluster size of a 1.8 wt % polyacrylonitrile polymer solution with the sizes of valleys 215 between walls 210 in patterned CNT carpet 189. In this embodiment, the median cluster size (D50) of the polymer in solution was about 80 μand created an average valley spacing of about 80 μm. Though not shown, an embodiment with a D50 of the cluster size of the polymer in solution of about 10 μm yielded an average valley spacing of about 10 μm, and an embodiment with a D50 of the cluster size of the polymer of about 1 μm yielded an average valley spacing of about 1 μm.

In some embodiments, polymer electrolyte, e.g. polyacrylic acid containing lithium salt such as LiFSI, is incorporated within the densified CNT walls 210 and forms solid electrolyte particles thereon. The polymer electrolyte can be made by mixing lithium salts, e.g. LiFSI, LiTFSI, and LiPF6, with the polymer solution. The solution can be used to coat CNT carpet 105 or a free-standing or self-supporting CNT carpet to form e.g. LiFSI, LiTFSI, or LiPF6, with a dispersion containing a polymer and CNTs before drying.

The molecules of polymer adhesive 130 can be physically or chemically crosslinked. The polymer solution may contain a crosslinking agent that initiates a crosslinking reaction upon filtration of the polymer solution into the CNT carpet. One such polymer solution is prepared by mixing 10 g polyethylene glycol, 10 g tetracthylene glycol dimethyl ether (TEGDME) solvent, 5.6 g LiFSI salt, and 2.2 g 4-methylbenzophenone (MBP) powder as a solubilizing agent in a plastic container using a planetary mixer at 800 rpm. The resulting mixture is blade coated on CNT carpet 105 and dried at 70° C., leaving a residual adhesive film. The film is later exposed to UV light for about 5 minutes to activate crosslinking.

In some embodiments, inorganic particles of solid electrolyte, e.g. tetraphosphorous decasulfide (P₄S₁₀), Li₇La₃Zr₂O₁₂ (LLZO), are mixed with polymer adhesive and incorporated within the densified CNT walls. The resultant adhesive material can coat walls 210 and floors 300. A polymer adhesive can be similarly applied to a free-standing or self-supporting CNT carpet to form a densified and macroporous CNT carpet with inorganic solid electrolyte particles. In some embodiments, a variant of the material is made by mixing the inorganic particles of solid electrolyte, e.g. P₄S₁₀ or LLZO, with a dispersion of CNTs before freeze drying or critical point drying to form a densified and macroporous CNT carpet with inorganic solid electrolyte particles.

In some embodiments, particles of active electrode materials, e.g. sulfurized carbon, silicon, or silicon oxide, are incorporated within and can coat the densified CNT walls. In some embodiments, adhesive material is made by mixing particles of the active electrode material particles with a polymer solution and applying the resultant mixture to the CNTs of e.g. a substrate-supported CNT carpet or a free-standing or self-supporting CNT carpet. Subsequent heat drying forms a densified and macroporous CNT carpet with active electrode material particles. In some embodiments, a variant of the material is made by mixing the active electrode material particles, e.g. sulfurized carbon, silicon, silicon oxide, with the dispersion of carbon nanotubes before freeze drying or critical point drying to form densified and macroporous CNT carpet with active electrode material particles.

Lithium metal is deposited within and between densified CNT walls 210. In some embodiments, the lithium metal is deposited predominantly within CNT walls 210, the densified CNT walls predominantly contain micropores (<2 nm) and mesopores (2-50 nm). In some embodiments, the pore volume of densified CNT walls 210 is predominantly of macropores (>50 nm) and lithium is deposited predominantly within the macropores. In some embodiments, the lithium metal is deposited predominantly between the densified CNT walls, whereby the space between the densified CNT walls is macroporous, greater than 1 μm, or even greater than 100 μm in some embodiments. In some embodiments lithium reacts with polymer molecules or clusters of polymer molecules on and within CNT walls 210 to form a solid electrolyte interphase.

The foregoing embodiments focus on vertically aligned CNTs as the nanofilaments treated with adhesive 130. Different types and combinations of nanofilaments can be used in other embodiments. For example, CNTs can be split into graphene nanoribbons, or filaments of different materials or combinations of materials can be used. For example, Zhang et al. “Splitting of a Vertical Multiwalled Carbon Nanotube Carpet to a Graphene Nanoribbon Carpet and Its Use in Supercapacitors,” ACS Nano 2013, 7, 6, 5151-5159, 14 May 2013, describe a carpet of carbon nanoribbons. Carpets of other nanofilaments might also be used. Moreover, adhesives can be applied to disordered nanofilament materials, such as free-standing CNT membranes. Free-standing CNT membranes, in which random networks of CNTs form very small pores, can be used to e.g. filter particles down to the nanoscale. Adhesives applied as detailed herein can be used to adjust the sizes and distributions of such pores.

While the invention has been described with reference to specific embodiments thereof, various modifications and changes may be made thereto without departing from the broader spirit and scope of the invention. For example, nanofilament carpets can be used in a variety of sensors, such as pressure sensors, temperature sensors, and chemical sensors. They can also be used to create nanoscale transistors, which can be used in computer chips and other electronic devices. Due to their high thermal conductivity, carbon-based nanofilament carpets make excellent thermal interface materials. Nanofilament carpets can also be effective field emitters because of their sharp tips and high electrical conductivity. Other applications will be evident to those of skill in the art. Therefore, the spirit and scope of the appended claims should not be limited to the foregoing description. Only those claims specifically reciting “means for” or “step for” should be construed in the manner required under the sixth paragraph of 35 U.S.C. § 112.

What is claimed is:

1. An electrode comprising:
a conductive substrate;
bundles of carbon nanofilaments, the bundles having:
bundle bases attached to the conductive substrate and an average inter-bundle spacing greater than ten nanometers at the bases of the bundles; and
bundle tops opposite the bundle bases and having an average inter-filament spacing of less than five nanometers at the bundle tops; and
a solid polymer between the bundles and in contact with the bundle bases and the conductive substrate.

2. The electrode of claim 1, wherein the nanofilaments include at least one of carbon nanotubes and carbon nanoribbons.

3. The electrode of claim 1, further comprising a coating of a metal over the solid polymer and over and between the carbon nanofilaments.

4. The electrode of claim 3, wherein the polymer is ionically permeable, allowing for deposition of the metal on the carbon nanofilaments at a current density of at least 1 mA/cm² within a voltage range of +/−0.1 V vs Li⁺/Li.

5. The electrode of claim 4, wherein the polymer is porous.

6. The electrode of claim 4, wherein the polymer is electrically insulating.

7. The electrode of claim 1, wherein the polymer consists of polymer molecules having an average molecular weight of less than 5 MDa.

8. The electrode of claim 1, wherein the polymer consists of polymer molecules having an average cluster size of more than 1 μm.

9. The electrode of claim 1, wherein the polymer comprises polyacrylonitrilc.

10. The electrode of claim 1, wherein carbon nanofilaments extend into the conductive substrate.

11. The electrode of claim 10, wherein the conductive substrate comprises copper and an interfacial layer, and wherein the bundles are attached to the copper via the interfacial layer.

12. The electrode of claim 11, wherein the interfacial layer comprises a catalyst to catalyze growth of the bundles.

13. A method of binding carbon nanofilaments to a substrate from which the carbon nanofilaments extend, the method comprising:
applying a polymer solution to the carbon nanofilaments;
wetting the substrate with the polymer solution between the carbon nanofilaments; and
drying the carbon nanofilaments and the substrate, the drying leaving a polymer residue binding the carbon nanofilaments to the substrate.

14. An electrode comprising:
a substrate; and
a nanofilament carpet on the substrate and occupying a carpet volume, the nanofilament carpet including:
walls of carbon nanofilaments having nanofilament spacings of a collective intra-wall volume fraction of the carpet volume; and
valleys surrounded by the walls and having a collective valley volume fraction at least double the intra-wall volume fraction.

15. The electrode of claim 14, further comprising a polymer over and within the walls.

16. The electrode of claim 15, wherein the polymer is a solid.

17. The electrode of claim 16, the polymer bonding the walls to the substrate.

18. The electrode of claim 14, wherein the carbon nanofilaments within the walls are bundled and the bundles have an average inter-bundle spacing that declines as a function of distance from the substrate.

19. The electrode of claim 14, wherein the walls have a wall thickness that tapers as a function of distance from the substrate.

20. The electrode of claim 19, wherein the walls have wall tops and wall bases, and wherein the wall thickness at the wall tops is on average less than half the wall thickness at the wall bases.

21. The electrode of claim 14, wherein the walls form a mosaic of the valleys from a perspective normal to the substrate.

21. The electrode of claim 13, wherein the walls include lamellas of the carbon nanofilaments.
